(19) United States
(12) Patent Application Publication
(10) Pub. No.: US 2018/0100705 A1
(43) Pub. Date: Apr. 12, 2018

(54) Extruded Tube For Simplifying The Formation Of An Internal Heat Exchanger For A Closed Cycle Refrigeration System

(71) Applicant: Penn Aluminum International LLC, Murphysboro, IL (US)

(72) Inventors: Barton C. Potter, Murphysboro, IL (US); Manikantha Reddy Daggula, Murphysboro, IL (US); James R. Martin, Murphysboro, IL (US); Aaron L. Norris, Murphysboro, IL (US)

(21) Appl. No.: 15/724,551

(22) Filed: Oct. 4, 2017

Related U.S. Application Data
(60) Provisional application No. 62/406,747, filed on Oct. 11, 2016.

(51) Int. Cl. F28D 7/10; B23P 15/26

(52) U.S. Cl. CPC F28D 7/10; B23P 15/26

(57) ABSTRACT

A heat exchanger is formed of inner and outer fluid tubes. The inner fluid tube has a profile that undulates in a smooth manner toward and away from the centroid of the inner fluid tube as the profile extends circumferentially about the centroid. The inner tube has axially opposite end margins that each form cylindrical tube portions. The cylindrical tube portions have a diameter greater than the diameter of the remainder of the inner fluid tube. The inner fluid tube defines an inner fluid passageway. The outer fluid tube encircles the inner fluid tube and extends from one of the cylindrical tube portions of the inner fluid tube to the other in a manner defining an outer fluid passageway between the inner fluid tube and the outer fluid tube. The outer fluid tube has an inlet and an outlet that extend radially through the outer fluid tube.

### CROSS-REFERENCE TO RELATED APPLICATIONS

The present application is a non-provisional application claiming the benefit of U.S. Provisional App. Ser. No. 62/406,747, filed Oct. 11, 2016, which is incorporated herein by reference in its entirety.

### STATEMENT REGARDING FEDERALLY SPONSORED RESEARCH OR DEVELOPMENT

Not Applicable.

### APPENDIX

Not Applicable.

### BACKGROUND OF THE INVENTION

### Field of the Invention

This invention relates generally to refrigerant heat exchangers. More particularly, the present invention pertains to a coaxial heat exchanger and method of forming the same.

### General Background

Coaxial heat exchangers are used for various purposes. One such use of coaxial heat exchanger is in an internal heat exchanger (IHX) of an air-conditioning system. As shown in FIG. 1, a refrigerant type air conditioner can include an IHX, which provides such an air conditioner with greater efficiency than it otherwise would have. Due to the high demand on efficiency in the automotive industry, most new automobile air-conditioning systems include an IHX. As shown in FIG. 1, an IHX exchanges heat between refrigerant that has left the condenser but that has yet to pass through the expansion valve with refrigerant that has left the evaporator but that has yet to reach the compressor. This effectively lowers the temperature of the refrigerant upstream of the expansion valve. It also increases the temperature of the refrigerant immediately upstream of the compressor, but overall efficiency is nonetheless improved.

### SUMMARY OF THE INVENTION

The present invention allows a concentric tube IHX to be formed in a simple manner, without losing structural integrity.

In one aspect of the invention, a heat exchanger comprises a monolithic inner fluid tube and an outer fluid tube. The inner fluid tube has a length and an annular transverse cross-sectional profile at its longitudinal center. The annular transverse cross-sectional profile has a centroid, a maximum diameter, and undulates in a smooth manner toward and away from the centroid as the annular transverse cross-sectional profile extends circumferentially about the centroid. The inner tube has axially opposite end margins that each form cylindrical tube portions. The cylindrical tube portions have a diameter greater than the maximum diameter of the annular transverse cross-sectional profile. The inner fluid tube defines an inner fluid passageway encircled by the inner fluid tube. The outer fluid tube encircles the inner fluid tube and extends from one of the cylindrical tube portions of the inner fluid tube to the other of the cylindrical tube portions of the inner fluid tube in a manner defining an outer fluid passageway that extends between the inner fluid tube and the outer fluid tube. The outer fluid tube defines an inlet and an outlet that extend through the outer fluid tube. The outer fluid tube is sealed to the cylindrical tube portions of the inner fluid tube in a manner such that the inlet and outlet provide the only fluid access to the outer fluid passageway.

In another aspect of the invention, a method of forming a heat exchanger comprises altering a monolithic first fluid tube, thereafter extending the first fluid tube through a second fluid tube, and sealing the second fluid tube to the first fluid tube. The first fluid tube has an original configuration prior to the altering and a finished configuration following the altering. The first fluid tube has a uniform transverse cross-sectional profile when the first fluid tube is in its original configuration. The cross-sectional profile has a centroid, a maximum diameter, and undulates in a smooth manner toward and away from the centroid as the annular transverse cross-sectional profile extends circumferentially about the centroid. The cross-sectional profile has a constant thickness as it extends circumferentially around the centroid. The first fluid tube has axially opposite end margins that each form cylindrical tube portions after the first fluid tube is altered from the original configuration to the finished configuration. The cylindrical tube portions have a diameter greater than the maximum diameter of the annular transverse cross-sectional profile. The cylindrical tube portions have a wall thickness approximately equal to the thickness of the cross-sectional profile. The first fluid tube defines an inner fluid passageway encircled by the first fluid tube. The second fluid tube is shorter than the first fluid tube and extends from a first end that encircles one of the cylindrical tube portions of the first fluid tube to a second end that encircles the other of the cylindrical tube portions of the first fluid tube. The second fluid tube has an inlet adjacent the first end of the second fluid tube and an outlet adjacent the second end of the second fluid tube. The sealing of the second fluid tube to the first fluid tube defines an outer fluid passageway that extends between the first fluid tube and the second fluid tube and is only in fluid communication with the inlet and outlet of the second fluid tube.

Further features and advantages of the present invention, as well as the operation of the invention, are described in detail below with reference to the accompanying drawings.

### BRIEF DESCRIPTION OF THE DRAWINGS

FIG. 1 depicts a flow diagram of refrigerant in an air-conditioning system without an IHX as compared to an air conditioning system with an IHX.

FIG. 2 depicts a perspective view of a fully assembled concentric tube IHX in accordance with the invention.

FIG. 3 depicts a top view of the IHX shown in FIG. 2.

FIG. 4 depicts a cross-section of the IHX shown in FIGS. 2 and 3, taken about the line A-A shown in FIG. 3.

FIG. 5 depicts a cross-section of the IHX shown in FIGS. 2 and 3, taken about the line B-B shown in FIG. 3.

FIG. 6 depicts a perspective view of the inner fluid tube of the IHX shown in FIGS. 2 and 3 by itself and in its finished configuration.

FIG. 7 is an end view of the inner fluid tube shown in FIG. 6.

FIG. 8 is a transverse cross-sectional view of the inner fluid tube taken midway the line C-C shown in FIG. 6.

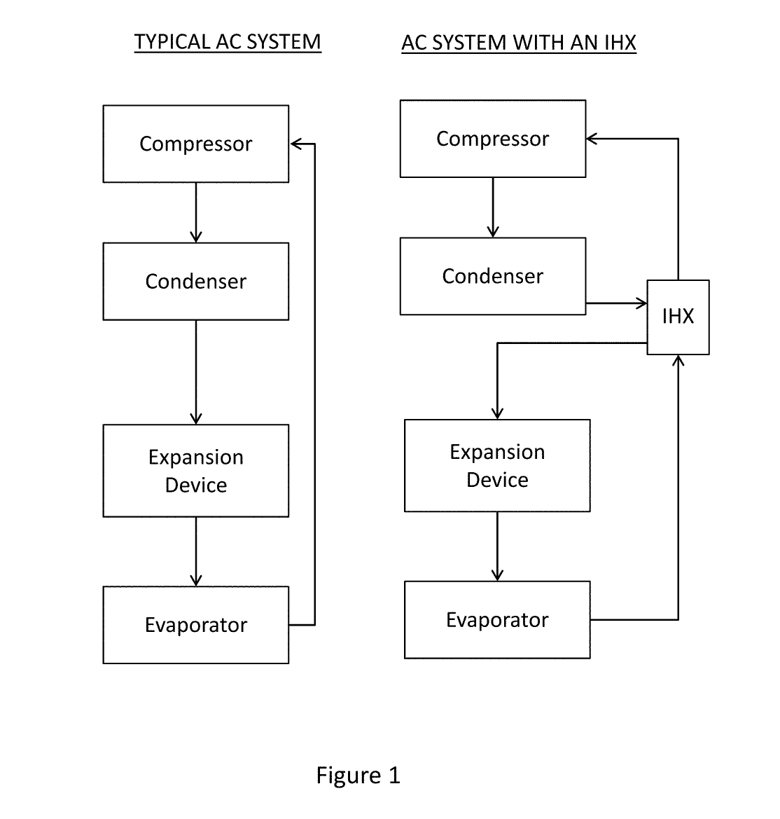

Reference numerals in the written specification and in the drawing figures indicate corresponding items.

### DETAILED DESCRIPTION

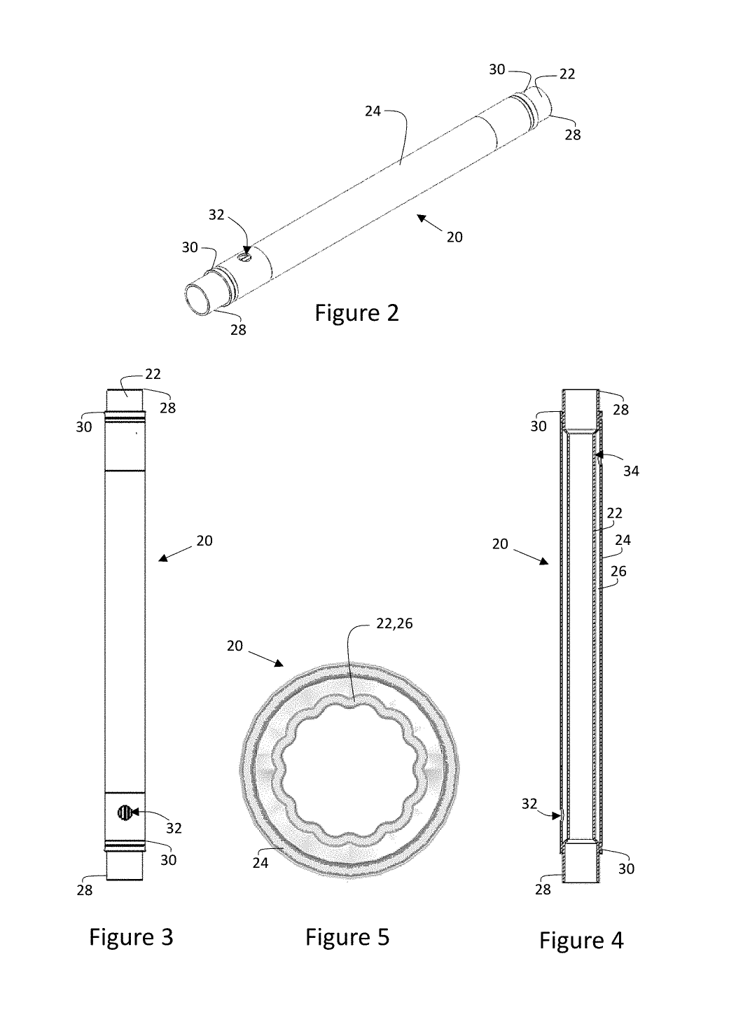

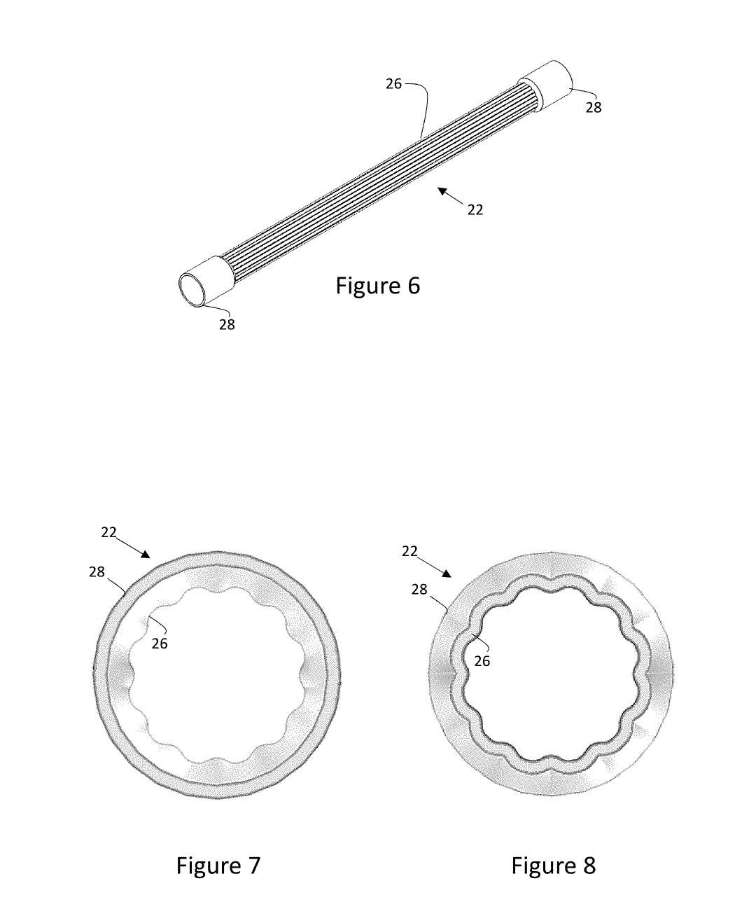

An IHX in accordance with the invention is shown in FIGS. 2-5. The IHX 20 comprises an inner fluid tube 22 and an outer fluid tube 24. The inner fluid tube 22 is shown by itself in FIGS. 6-8. The inner tube 22 is preferably formed from an extrusion, and preferably is formed of aluminum. The extruded tube preferably has an undulating contour having the cross-section shown in FIG. 8. The undulating contour undulates in a smooth manner toward and away from the centroid of the inner fluid tube 22 as the annular transverse cross-sectional profile of the inner fluid tube extends circumferentially about the centroid of the inner fluid tube. Preferably the wall 26 of the inner fluid tube 22 maintains a constant thickness as it undulates. The undulation of the wall 26 increases the surface area of the inner fluid tube 22, but also serves the purpose of allowing the inner fluid tube to easily be flared without decreasing the thickness of the wall when flared. As shown in FIG. 6, the inner fluid tube 22 is cut to a desired length and then the opposite end margins 28 of the cut tube are flared such that the end margins are cylindrical. The configuration of the undulation of the wall 26 of the inner fluid tube 22 is designed such that the end margins 28 of the inner fluid tube can be formed to a particular diameter without a change in wall thickness when the undulation is removed from the end margins. The internal faces of the cylindrical end margins 28 are configured to receive refrigerant lines and operatively connect an evaporator to a compressor.

The outer fluid tube 24 is cylindrical and is dimensioned to receive the inner fluid tube 22 with the end margins 28 of the inner fluid tube snugly engaging against the inner surface of the outer fluid tube. The outer fluid tube 24 is preferably slightly shorter that the inner fluid tube 22 and is preferably formed of aluminum. As such, the end margins 30 of the outer fluid tube 24 can easily be welded or brazed to the inner fluid tube 22. In addition, the end margins 30 of the outer fluid tube 24 can be crimped to the end margins 28 of the inner fluid tube 22 as shown in FIGS. 2-4. The outer fluid tube 24 also comprises an outlet 32 and an inlet 34 that are axially positioned adjacent the opposite ends of the outer fluid tube and the end margins 28 of the inner fluid tube 22. Preferably the outlet 32 and the inlet 34 face radially opposite directions. The inlet 34 is configured to connect to a liquid refrigerant line running from the condenser and the outlet is configured to connect to a liquid refrigerant line running to an expansion valve. Preferably the liquid refrigerant lines are welded or brazed to the outer fluid tube 32.

In view of the foregoing, it should be appreciated that the invention has several advantages over the prior art.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

It should also be understood that when introducing elements of the present invention in the claims or in the above description of exemplary embodiments of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations. Still further, the order in which the steps of any method claim that follows are presented should not be construed in a manner limiting the order in which such steps must be performed, unless such an order is inherent.

What is claimed is:

1. A heat exchanger comprising:
a monolithic inner fluid tube, the inner fluid tube having a length and an annular transverse cross-sectional profile at its longitudinal center, the annular transverse cross-sectional profile having a centroid, a maximum diameter, and undulating in a smooth manner toward and away from the centroid as the annular transverse cross-sectional profile extends circumferentially about the centroid, the inner tube having axially opposite end margins that each form cylindrical tube portions, the cylindrical tube portions having a diameter greater than the maximum diameter of the annular transverse cross-sectional profile, the inner fluid tube defining an inner fluid passageway encircled by the inner fluid tube;
an outer fluid tube, the outer fluid tube encircling the inner fluid tube and extending from one of the cylindrical tube portions of the inner fluid tube to the other of the cylindrical tube portions of the inner fluid tube in a manner defining an outer fluid passageway that extends between the inner fluid tube and the outer fluid tube, the outer fluid tube defining an inlet and an outlet that extend through the outer fluid tube, the outer fluid tube being sealed to the cylindrical tube portions of the inner fluid tube in a manner such that the inlet and outlet provide the only fluid access to the outer fluid passageway.

2. A heat exchanger in accordance with claim 1 wherein the annular transverse cross-sectional profile of the inner fluid tube has a constant thickness that extends circumferentially about the centroid.

3. A heat exchanger in accordance with claim 1 wherein a plane extends through the centroid of the annular transverse cross-sectional profile of the inner fluid tube and through the cylindrical tube portions of the inner fluid tube, the inlet and outlet of the outer fluid tube being positioned on opposite sides of the plane.

4. A heat exchanger in accordance with claim 1 wherein the outer fluid tube is generally cylindrical.

5. A heat exchanger in accordance with claim 4 wherein the outer fluid tube is crimped to the cylindrical tube portions of the inner fluid tube.

6. A heat exchanger in accordance with claim 1 wherein the outer fluid tube is brazed to the cylindrical tube portions of the inner fluid tube cylindrical tube portions of the inner fluid tube.

7. A method of forming a heat exchanger, the method comprising:
altering a monolithic first fluid tube, the first fluid tube having an original configuration prior to the altering and a finished configuration following the altering, the first fluid tube having a uniform transverse cross-sectional profile when the first fluid tube is in its original configuration, the cross-sectional profile having a centroid, a maximum diameter, and undulating in a smooth manner toward and away from the centroid as the annular transverse cross-sectional profile extends circumferentially about the centroid, the cross-sectional profile having a constant thickness as it extends circumferentially around the centroid, the first fluid tube having axially opposite end margins that each form cylindrical tube portions after the first fluid tube is altered from the original configuration to the finished configuration, the cylindrical tube portions having a diameter greater than the maximum diameter of the annular transverse cross-sectional profile, the cylindrical tube portions having a wall thickness approximately equal to the thickness of the cross-sectional profile, the first fluid tube defining an inner fluid passageway encircled by the first fluid tube;
extending the first fluid tube through a second fluid tube after the step of altering the first fluid tube, the second fluid tube being shorter than the first fluid tube and extending from a first end that encircles one of the cylindrical tube portions of the first fluid tube to a second end that encircles the other of the cylindrical tube portions of the first fluid tube, the second fluid tube having an inlet adjacent the first end of the second fluid tube and an outlet adjacent the second end of the second fluid tube;
sealing the second fluid tube to the first fluid tube in a manner defining an outer fluid passageway that extends between the first fluid tube and the second fluid tube and is only in fluid communication with the inlet and outlet of the second fluid tube.

8. A method of forming a heat exchanger in accordance with claim 7 wherein the second fluid tube only contacts the first fluid tube at the cylindrical tube portions of the first fluid tube.
